(19) United States
(12) Patent Application Publication
(10) Pub. No.: US 2018/0045807 A1
(43) Pub. Date: Feb. 15, 2018

(54) Global Positioning System and Ultra Wide Band Universal Positioning Node Consellation integration

(71) Applicant: 5D Robotics, Inc., Carlsbad, CA (US)

(72) Inventors: Josh Senna, Carlsbad, CA (US); Brandon Dewberry, Huntsville, AL (US); David Bruemmer, Carlsbad, CA (US)

(73) Assignee: 5D Robotics, inc., Carlsbad, CA (US)

(21) Appl. No.: 15/675,720

(22) Filed: Aug. 12, 2017

Related U.S. Application Data
(60) Provisional application No. 62/374,171, filed on Aug. 12, 2016.
(60) Provisional application No. 62/537,062, filed on Jul. 26, 2017.

(51) Int. Cl. G01S 5/14; G01S 5/00

(52) U.S. Cl. CPC G01S 5/14; G01S 5/0081; G01S 5/0045

(57) ABSTRACT

Gaining a time signal from a radio signal such as GPS, an ultra-wide band constellation can be synchronized. While the entirety of the constellation is synchronized to a nanosecond level of accuracy, local subsets of ultra-wide band nodes can establish even finer degrees of synchronization resulting in more accurate positional determination. These synchronization signals can be propagated to other nodes that are denied or incapable of receiving synchronizing radio (GPS) signals. Moreover, in cases in which a plurality of UPN nodes is unavailable to accurately determine an objects position, available UPN nodes can be combined with GPS pseudo ranges to achieve positional determination.

### RELATED APPLICATION

The present application relates to and claims the benefit of priority to U.S. Provisional Patent Application Nos. 62/374171 filed 12 Aug. 2016 and 62/537062 filed 26 Jul. 2017, which are hereby incorporated by reference in their entirety for all purposes as if fully set forth herein.

### BACKGROUND OF THE INVENTION

### Field of the Invention

Embodiments of the present invention relate, in general, to positioning technology and more particularly to integrating Global Positioning System capabilities with a constellation formed using Ultra-Wide Band technology.

Relevant Background.

Ultra-Wide Band (“UWB”) radios combined with inertial and dead reckoning techniques can establish a precise position of an object in a variety of environments in which a Global Navigation Satellite System (GNSS) such as the Global Positioning System (“GPS”) or similar satellite based positioning systems fail. For example, it is well known that GPS signals experience multipath errors in mountainous and urban environments which significantly reduce the accuracy and reliability of GPS positional techniques. And in environments in which GPS signals are occluded, no positional capability is possible. AEven when a GPS receives an unobstructed signal from three or more satellites, positional accuracy is still insufficient to reliably enable autonomous operations. In such environments, UWB techniques can establish robust and precise positional determinations but the range of each UWB transceiver is limited.

Dedicated Short Range Communications (“DSRC”) is a standardized Vehicle-To-Vehicle (“V2V”) and Vehicle-To-Infrastructure (“V2I”) communication technique used for traffic management. DSRC is a two-way short-to-medium-range wireless communications capability that permits very high data rate transmissions in critical communications-based active safety applications. V2V and V2I applications utilizing DSRC can reduce many of the deadliest types of crashes through real time advisories alerting drivers to imminent hazards—such as veering close to the edge of the road; vehicles suddenly stopped ahead; collision paths during merging; the presence of nearby communications devices and vehicles; sharp curves or slippery patches of roadway ahead, and the like. V2I services like e-parking and toll payment are also able to be communicated using DSRC and anonymous information from electronic sensors in vehicles and devices can also be transmitted over DSRC to provide better traffic and travel condition information to travelers and transportation managers.

While DSRC has been effectively implemented to aid in public safety applications and traffic applications including blind spot warnings, forward collision warnings, sudden braking ahead warnings, do not pass warnings, approaching emergency vehicle warnings, emergency vehicle signal priority, electronic payment of tolls and parking, commercial vehicle safety inspections, and traffic conditions, it lacks the ability to precisely determine and communicate the position of the vehicle.

What is needed is an ability to integrate UWB positional capabilities with those of GPS and DSRC to enable precise and robust vehicle positioning in environments in which GPS and similar positional techniques are either denied or rendered ineffective. These and other inadequacies of the prior art are addressed by one or more embodiments of the present invention. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

A constellation of Ultra-Wide Band (UWB) nodes fixedly positioned over a geographic area with known locations creates a network that enables precise positional determination of participating and nonparticipating objects alike. The constellation of UWB nodes, in which each node operates both as a UWB transceiver and as a monostatic/bi-static UWB radar, allows similarly equipped mobile nodes to establish their precise spatial location. Connectivity between the nodes is maintained through peer-to-peer UWB communication and the Dedicated Short-Range Communications (“DSRC”) system. The present invention uses, among others, positional techniques such as Two-Way Ranging and Time Difference of Arrival to ascertain the position of each mobile device. These techniques are supplemented with Global Positioning System (GPS) temporal information. Using a GPS signal as clock reference, the UWB constellation can be coarsely synchronized globally, while enabling refined local peer-to-peer synchronization and positional determination using UWB transceivers.

Another embodiment of the present invention integrates UWB positional Nodes with DSRC technology to allow for maximum peer-to-peer communication and provide useful data that can be leveraged in both existing and new systems. Having a common reference time throughout the constellation, integration of the two technologies provides precise communication, positioning and guidance in areas where GPS is denied such as tunnels and urban environments having tall buildings resulting in multi-path errors. Using UWB assisted positional determination, vehicles can obtain centimeter level accurate positioning in tunnels, urban canyons and underpasses which can be conveyed using DSRC. Such precision enables automated operations and intelligent traffic control.

According to one embodiment of the present invention, a plurality of Ultra-Wide Band (UWB) positional nodes are fixedly positioned throughout a geographic area forming a UWB constellation. The synchronized UWB geographic positioning system of the present invention provides precise positional determination combined with the ability to share locational information and similar related traffic and safety data throughout the constellation.

Each UWB Positional Node (UPN) of the present invention includes an UPN UWB transceiver and an UPN radio transceiver. Each UPN is within an effective UPN UWB transceiver range of two or more other UPNs and each UPN includes a clock that maintains a node reference time. The UWB geographic positioning system also includes a radio signal, transmitted by a radio and received by one or more other UPNs in the geographic area in which the radio signal includes a radio signal time stamp. A processor at each UPN, communicatively coupled to its UPN radio transceiver and its clock, synchronizes the node reference time maintained by this clock to the radio signal time.

Another aspect of the present invention is that the determination whether to synchronize a UPN's node reference time with the radio signal time is based on a dynamic weighted average error assessment of the node reference time and the radio signal time. In addition, responsive to determination that the dynamic weighted average error assessment exceeds a predetermined threshold, the UPN synchronizes its node reference time with the node reference time of a second UPN when the second UPN is within the effective UWB transceiver range of the first UPN.

According to another embodiment of the present invention, the radio signal time is established as a constellation common reference time having a first degree of accuracy. Moreover, the plurality of UPNs forming the constellation can include a first subset of UPNs as well as a second subset of UPNs. The first subset of UPNs establishes a first subset reference time having a second degree of accuracy based on the constellation common reference time. Similarly, the second subset of UPNs establishes a second subset reference time having a third degree of accuracy, also based on the constellation common reference time. According to one embodiment of present invention, the second degree of accuracy is greater than the first degree of accuracy and also the third degree of accuracy is greater than the first degree of accuracy. These distinct degrees of accuracy are maintained making the first subset time independent from the second subset time. Accordingly, a movably positioned object in the first subset of UPNs, having an object reference time, synchronizes its object reference time with the first subset reference time and the second degree of accuracy for positional determination. And while Time Differences of Arrival (TDOA) calculations are based on the second degree of accuracy, a schedule by which to conduct TDOA and similar communications within each subset is based on the first degree of accuracy.

Another aspect of the present invention is that the radio signal is a global positioning system (GPS) signal and once established, each UPN UWB transmitter can propagate its node reference time using a UWB pulse. In another embodiment of the present, invention the common node time is propagated throughout the constellation using a Dedicated Short-Range Communications (DSRC) radio signal. The system can further comprise two or more movably positioned objects. Each movably positioned object includes an object reference time, an object UWB transceiver having an object UWB transceiver effective range and each movably positioned object synchronizes its object reference time with a weighted average of each node reference time received from two or more UPNs within the object UWB transceiver effective range.

Where there are more than one movably positioned object a first movably positioned object determines its position at a first point in time, and communicates its position at that first point of time with other UPNs within the UWB transceiver effective range. Similarly, a second movably positioned object determines its position at the same first point in time, and communicates its position at that first point of time with UPNs within the UWB transceiver effective range. By doing so all of the movably positioned objects are aware of their respective positions at the same point of time.

Another feature of the present invention combines UWB positional determination techniques with position information gained from GPS. In one embodiment, the processor of a movably positioned object determines its position by combining time differences of arrival of measurements gained from signals transmissions by one or more UPNs within the object UWB transceiver effective range and one or more GPS signals transmitted from a plurality of GPS radios.

Methodology to implement the system for positional determination in a geographic area is also an aspect of the present invention. One such methodology includes fixedly positioning a plurality of Ultra-Wide Band (UWB) Positional Nodes within a geographic area to form a UWB constellation. Each UWB Positional Node (UPN) includes, a processor, an UPN UWB transceiver, a UPN radio transceiver and a clock that maintains a node reference time and receives a radio signal wherein the radio signal includes a radio signal time. The methodology continues by synchronizing the node reference time maintained by the clock to the radio signal time forming a constellation common reference time. This constellation common reference time is associated with a first degree of accuracy.

The methodology of the present invention also includes forming a first subset of UPNs and forming a second subset of UPNs. It continues by establishing a first subset reference time by the first subset of UPNs having a second degree of accuracy based on the constellation common reference time, and establishing a second subset reference time by the second subset of UPNs having a third degree of accuracy based on the constellation common reference time. The second degree of accuracy is greater than the first degree of accuracy and the third degree of accuracy is greater than the first degree of accuracy and, lastly, the first subset time is independent from the second subset time.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 is a high-level block diagram of one of a plurality of Ultra-Wide Band Positional Nodes used in forming a UWB constellation showing system components found in each node according to one embodiment of the present invention;

FIG. 2 is a high-level depiction of an UWB constellation in an urban environment according to one embodiment of the present invention;

FIG. 3 is an illustration of a pulsed based Time Distance of Arrival offset based on a synchronized radio time signal from a GPS satellite according to one embodiment of the present invention;

FIG. 4 is a rendering of a two movably positioned nodes and three UPNs using a combination of TDOA and TWR to ascertain the location of each movably positioned node at a common time reference, according to one embodiment of the present invention;

FIG. 5 illustrates the positional determination of an object by merging UWB and GPS positional techniques, according to one embodiment of the present invention; and

FIG. 6 is one embodiment of a methodology of the present invention for synchronization of a UWB constellation using a radio signal timestamp from a GPS radio signal.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

Gaining a time signal from a radio signal such as GPS, an Ultra-Wide Band constellation can be synchronized. While the entirety of the constellation is synchronized to a nanosecond level of accuracy, local subsets of Ultra-Wide Band nodes can establish even finer degrees of synchronization resulting in more accurate positional determination. These synchronization signals can be propagated to other nodes that are denied or incapable of receiving synchronizing radio (GPS) signals. Moreover, in cases in which a plurality of UPN nodes alone is unavailable to accurately determine an objects position, available UPN nodes can be combined with GPS pseudo ranges to achieve positional determination. And these GPS pseudo ranges can be further refined by tightly coupling RTK phase measurements with possible UPN solutions.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

With respect to the present invention the following terms will interpreted as possessing the following meaning.

As used herein, Ultra-Wide Band (UWB) refers to very short Radio Frequency (RF) pulses of low duty cycle ideally approaching a Gaussian Monocycle. Typically, these pulses have a relative bandwidth (i.e., signal bandwidth/center frequency) which is greater than 25%. The ultra-wide band nature of these pulses improves both angle and range resolution, which results in improved performance (e.g., greater selectivity, more sensitive motion detection). The term “wavelength”, as used herein in conjunction with UWB systems, refers to the wavelength corresponding to the center frequency of the UWB pulse.

DSRC is a two-way short-to-medium-range wireless communications capability that permits very high data transmission critical in communications-based active safety applications. The Federal Communications Commission (FCC) allocated 75 MHz of spectrum in the 5.9 GHz band for use by Intelligent Transportations Systems (ITS) vehicle safety and mobility applications. DSRC technology supports the communication routes for vehicle-to-vehicle (V2V) and vehicle-to-infrastructure (V2I) (V2X refers to the combination of V2I and V2I) data exchanges. DSRC was developed with a primary goal of enabling technologies that support safety applications and communication between vehicle-based devices and infrastructure to reduce collisions.

The Universal or Ultra-Wide Band Positional Nodes (UPNs) of the present invention comprises hardware and software components that can be fixedly (with a known location) installed for connectivity and positional determination among people, things, and vehicles (both air and ground). Each UPN of the present invention provides 1) intelligent connectivity for peer to peer communications, and 2) a set of data about what is happening in the surrounding environment. With this communication and supplied data the environment becomes more intelligent for improving the safety, efficiency and movement of objects. The present invention improves communications and positional awareness between people and things, and with the improved communications and increased connectivity the UWB constellation improves an object's interaction with the environment. The UWB constellation also provides real-time data and communications for precise reliable navigation.

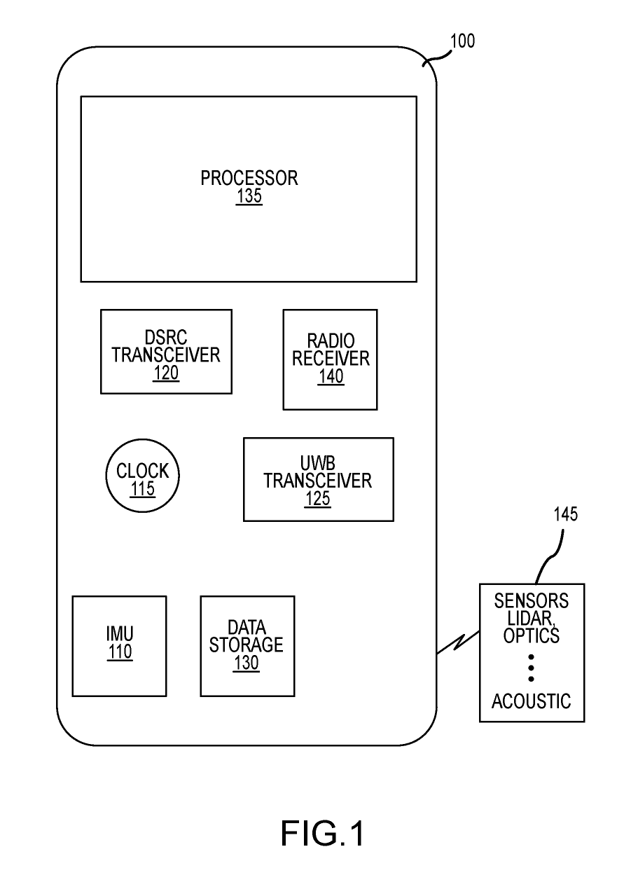

In one embodiment, UPNs 100 of the present invention, as shown in FIG. 1, comprise a) an inertial sensor (IMU) 110, b) a clock 115, c) wireless networking/communications network technology (DSRC) 120, d) a UWB transceiver that can operate as a monostatic and bi-static radar 125, e) data storage 130, (accessible real-time to other devices and applications), f) processor(s) 135, g) GPS receiver 140 and h) integration capability with other available components and sensors 145. Optional components can include a camera, LiDAR, Acoustic sensors, Bluetooth, WiFi, and a fusion algorithm that correlates, filters and fuses data, voice recognition information and the like.

The UWB constellation of the present invention crafts a Wireless networking/communications network using Ultra-Wide Band units that possess radar and ranging capabilities. A constellation, as the term is used herein, is any group of two or more UWB nodes within a predetermined range, for example within a 300-meter range of each other. One of reasonable skill in the relevant art will recognize that range limitations are a hardware and/or regulatory constraint and while the discussion that follows envisions relatively short-range communications between nodes, this discussion should in no way limit the scope of the invention if such range limitations are relaxed.

Once formed, the UPN network (constellation) can have a plurality of implementations including, integration with Traffic Lights based on seeing cars, obstacles, birds, people and even animals with UWB Radar, cross correlation of UWB radar based on tracking of people and vehicles against the constellation that can provide levels of authorization and prioritization for each, supplying data that can be used by public safety systems for predictive and re-active situations, identify available parking spots, notification of a variety of events such as: a) security breach b) illegal parking c) driveway blockage or other unsafe or illegal situations, and data that serves up x, y, z, θ and a unique ID to 3^{rd} Party applications for use on external applications and applications development. For example, a radar reflectivity scan would show differences between a long trailer versus a short trailer, when in a vehicle is in a turn versus going straight ahead or changes between an empty parking spot and a full parking spot. One or more modules mounted on a vehicle or infrastructure applying signal processing and pulling out desired features and data can determine changes in the environment. In the same manner boundaries can be defined, virtual designated lines in a road using a combination of software and hardware found in each UPN.

In one embodiment of the present invention, a smart light pole using the UPN technology of the present invention can include a module that a) activates a light based on UWB radar and/or constellation tracking; b) increases brightness of the lights to communicate hazards (ex: freeway debris); c) sends an alert if a vehicle is too close or about to hit something. Similarly, the present invention can use a UWB constellation to drive an autonomous personal mobility vehicle to meet a handicapped person who is parking and transport that person to an identified destination.

One key differentiation of the present invention is its use of a peer-to-peer position, time stamp for data that is collected, the storage schemes, and an aggregation scheme. The present invention uses, in one embodiment, a Time Series Database (TSDB) called Graphite. TSDBs store streaming values or metrics. The data sent to Graphite has the form: string, timestamp, measurement (where measurement is a 64-bit double). The string uniquely identifies where the data will be stored, and what it is associated with. In one embodiment, the string can take the form similar to: <Customer>/<Site>/<Asset>/<Metric>.

Data arriving in the database is stored according to a storage schema, which determines the time resolution of the data stored, and for how long, e.g. 1 second for 5 days, 1 minute for 30 days, 1 hour for 1 year, and so on. The present invention is a foundational architecture that allows multiple applications, devices, and forms of mobility to communicate in a V2X ecosystem. (Vehicle to Vehicle, Vehicle to Infrastructure, and Vehicle to Pedestrian)

The term GPS refers to the U.S. Global Positioning System, but any similar localization system (e.g., Russia's “GLONASS” or Europe's “Galileo”, etc.) can be used and the use of GPS broadly refers to all such schemes and localization systems. GPS is a space-based satellite navigation system that provides location and time information anywhere on or near the Earth where there is an unobstructed line of sight to four or more GPS satellites. (In some cases, a location determination can be made with three satellites.)

To determine a location on the earth, a GPS receiver calculates its position by precisely timing the signals sent by GPS satellites high above the Earth. Each satellite continually transmits messages that include the time the message was transmitted and the satellite position at time of message transmission.

The receiver uses the messages it receives to determine the transit time of each message and computes the distance or range to each satellite. These distances, along with the satellites' locations, are used to compute the position of the receiver. A satellite's position and range define a sphere, centered on the satellite, with radius equal to the range. The position of the receiver is somewhere on the surface of this sphere. Thus, with four satellites, the indicated position of the GPS receiver is at or near the intersection of the surfaces of four spheres. In the ideal case of no errors, the GPS receiver would be at a precise intersection of the four surfaces.

One of the most significant error sources is the GPS receiver's clock. Because of the very large value of the speed of light, c, the estimated distances from the GPS receiver to the satellites, the range, are very sensitive to errors in the GPS receiver clock; for example, an error of one microsecond (0.000001 second) corresponds to an error of 300 meters (980 ft.). This suggests that an extremely accurate clock is required for the GPS receiver to work; however, manufacturers prefer to build inexpensive GPS receivers for mass markets.

It is likely that the surfaces of the three GPS generated spheres intersect, because the circle of intersection of the first two spheres is normally quite large, and, the third sphere surface is likely to intersect this large circle. If the receiver's clock is wrong, it is very unlikely that the surface of the sphere corresponding to the fourth satellite will initially intersect either of the two points of intersection of the first three, because any clock error could cause it to miss intersecting a point. On the other hand, if a solution has been found such that all four spherical surfaces at least approximately intersect with a small deviation from a perfect intersection, then it is quite likely that an accurate estimation of receiver position will have been found and that the clock is quite accurate. An accurate clock signal is therefore, critical.

Time Distance of Arrival (TDOA) determines an object's location by merely receiving broadcast signals. In TDOA, (sometimes referred to as inverse TDOA) a plurality of nodes, such as in a UWB constellation, broadcast a signal at a precise time. Each signal identifies the transmitting node. The receiving UWB node receives two or more signals and notes each time of arrival. Knowing the location of each transmitting node and the different times that the signals arrived at the receiving node, the receiving nodes location can be determined. The time that the signal takes to arrive at the receiving node from the transmitting node creates a spheroid locus of points, centered on the transmitting node's known location. The intersection of three or more of these spheres, as with GPS, identifies the probabilistic location of the receiving node.

Two-Way Ranging (TWR) is the ability of UWB tags or radios to establish two-way ranging between objects (UWB Radio localization system). In such an instance one radio (node) transmits a request packet to another “target” node. The target node acquires the message, demodulates the packet and notes its precise time of arrival. After a precise and predetermined delay, relative to the time of arrival, the target node sends a response to the node originating the message. The requesting node receives the response and notes the time of arrival of the response. Knowing this is a two-way communication with a precise respondent, the receiving node calculates the total time from when the request was originally sent to when the response was received, subtracts the known delay and multiples the result by c/2. The result is a precise distance between the two nodes. Again, the result creates a spheroid locus of points, centered on the known location of the transmitting node. The intersection of three or more of these spheres identifies the probabilistic location of the receiving node as is described in more detail below.

Triangulation is a technique for establishing the distance between any two points, or the relative position of two or more points, by using such points as vertices of a triangle or series of triangles, such that each triangle has a side of known or measurable lengths that permits the size of the angles of the triangle and the length of its other two sides to be established by observations taken either upon or from the two ends of the base line.

Multilateration (MLAT) is a location technique based on the measurement of the difference in distance to two stations at known locations by broadcast signals at known times. Unlike measurements of absolute distance or angle, measuring the difference in distance between two stations results in an infinite number of locations that satisfy the measurement. When these possible locations are plotted, they form a hyperbolic curve. To locate the exact location along that curve, multilateration relies on multiple measurements: a second measurement taken to a different pair of stations will produce a second curve, which intersects with the first. When the two curves are compared, a small number of possible locations are revealed, producing a “fix”.

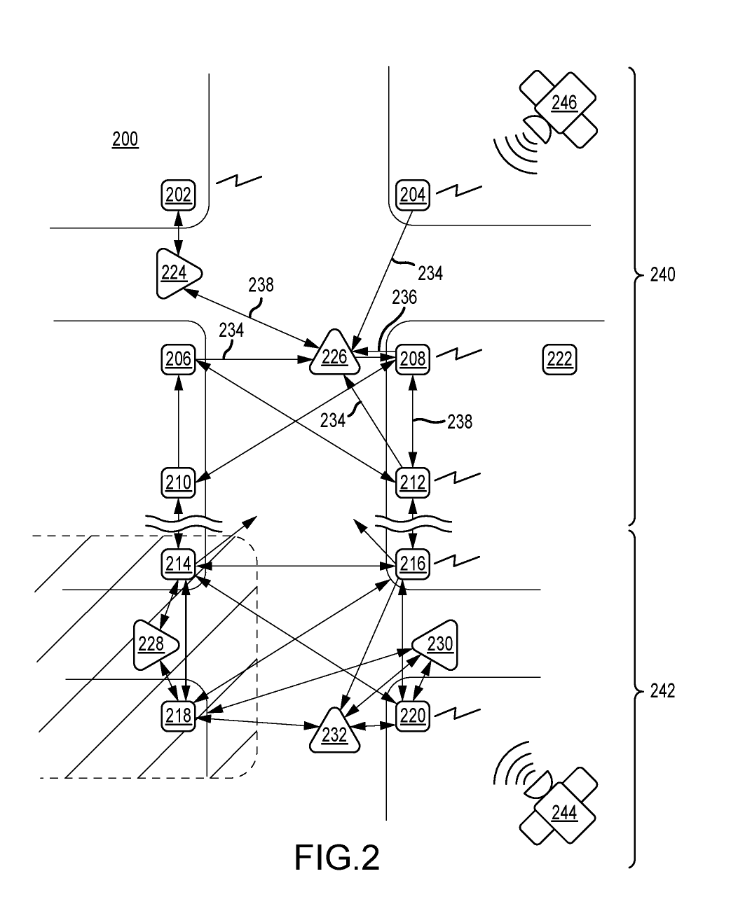

FIG. 2 is shows a high-level depiction of a UWB constellation 200 established in an urban environment according to one embodiment of the present invention. Each UPN 202, 204, 206, 208, 210, 121, 214, 216, 218, 220, 222 of the present invention includes a UWB transceiver 125 as well as a Radio transceiver 140 and each UPN is positioned within a geographic area so as to be within the UWB transceiver's effective range of two or more other UPNs.

The rendering of FIG. 2 presents an urban environment in which a plurality of UPNS are collocated with streetlights, traffic lights or similar infrastructure components. In each case, these infrastructure UPNs are fixedly positioned with a known location. Each location is recorded forming a list of known locations that is stored and maintained by other UPNs in the constellation. In other embodiments of the present invention, each UPN includes a list of the locations of UPNs within its effective UWB transceiver range which is communicated to other, nearby UPNs.

Within the environment are a plurality of movably positioned objects (vehicles) 224, 226, 228, 230, 232. Each movably positioned object is similar equipped with an object UWB transceiver 125 and an object radio transceiver 140. Using multilateration, a movably positioned object can determine its position within a great degree of precision. While a variety of positional sensors and techniques can aid in the determination of an object's position, two are exemplary of the innovation of the present invention.

Time differences of arrival, or TDOA 234, measures the differences in time of an arriving transmissions to determine the range between the transmitter and the receiver. A second methodology is Two-Way Ranging or TWR 236 in which the mobile object sends out a request to nearby UPNs. Each UPN, after a predetermined delay, responds identifying itself, its location, and, in some cases, the time that it received the transmission and the time that it sent the response. From this data, the movably positioned object can determine its distance from the UPN. If, as in the present case, the location of the transmitter (UPNs) is known, the determined distance between the transmitter and receiver forms a spheroid locus of points on which the receiving node exists. One of reasonable skill in the art will appreciate that the measurement of time from which distance is determined is subject to a certain degree of error. TWR is typically more precise than TDOA but it involves a second set of communication messages.

Upon gaining transmissions from three or more nodes, (whether using TDOA or TWR) all whose locations are known, distinct spheres can be constructed and overlaid. The intersection of these spheres is the probabilistic location of the movably positioned object.

One of reasonable skill in the relevant art will appreciate that the accuracy of the measurement of time, and thus the determination of distance, is critical to the accuracy of the positional determination. According to one embodiment of the present invention, each UPN and movably positioned object includes a radio transceiver that receives radio signals, such as a GPS transmission from which to synchronize its clock. GPS transmissions, and other radio signals, include a radio signal time stamp. One aspect to the present invention is the synchronization of each UPN within the constellation and each movably positioned node to the same reference time.

For example, in one embodiment, each UPN can include a GPS receiver. The GPS receiver receives the GPS signal which includes an accurate radio time signal with nanosecond precision. While the fixed UPNs are not interested in gaining a GPS positional determination, they can use the UPS radio signal time as a node reference time.

Moreover, each GPS signal includes a Pulse Per Second (PPS) voltage signal the enables precise external synchronization to the internal GPS clock. At each UPN, a PPS voltage line, along with a data channel, can output this radio signal timestamp on the upswing of the PPS signal. Using this signal, the internal GPS clock signal can be propagated throughout the constellation. Adding a Phase Lock Loop to lock the phases and calibrating the delays of the digital timestamp results in synchronization of the entire constellation to a nanosecond degree of accuracy.

In such a manner, each node in the constellation adopts the same reference time that is aligned with the GPS radio signal time. By doing so, a schedule of TDOA transmissions can be generated and aligned. Consider that a movably positioned object may be within an UWB effective transmission range of a plurality of UPNs. UPN transmissions must be discreet. These transmissions are scheduled creating what is commonly referred to as a slot map. Using the slot map each UPN can issue a TDOA transmission as well as respond to any TWR requests.

For example, consider the movably positioned object in the upper portion of FIG. 2. A movably positioned object 220 is within the effective reception range of no less than 4 UPNs and another movably positioned object. Using a radio time signal transmitted by a GPS satellite 246, each node's reference time is aligned to the GPS radio time signal. Such alignment enables the UPNs and the movably positioned device to utilize DSRC 238 to transmit data with respect to position, path, and the like.

While each UPN in a subset of UPNs receives and updates its node reference time to that of the radio signal time, they also align themselves to the same local time and the same local degree of accuracy. The degree of accuracy for each subset may differ. For example, the GPS radio signal time may have an error assessment of being accurate within a nanosecond. Consider two UPN subsets 240, 242 within the UWB constellation 200 shown in FIG. 2. While the time shared by each UPN in the subset of the upper portion 240 of FIG. 2 may be accurate to only a nanosecond, or a first degree of accuracy, they also share a local reference time accurate to a second degree of accuracy. This second degree of accuracy may be significantly better than the constellation time accuracy, for example, to a picosecond.

It is possible to synchronize each UPN within a local area to a second degree of accuracy through either GPS signals or UWB peer to peer signals. Nodes which are local to each other experience very similar atmospheric effects which add error to the GPS time signal. However, since this error is consistent within a local area each node in a local area is still second degree accurate to its local neighbors.

In order to achieve this level of timing accuracy from the GPS signal only clean LOS signals may be used, unlike first degree accuracy which can still be achieved even in multipath or NLOS conditions. However, timing determination is simpler that position and does not require as many satellites in view, while satellite coverage in an urban canyon may not be sufficient to position with GPS alone, there are usually enough satellites in direct LOS. By knowing the precise location of the fixed UPN, the UPN is able to reject timing information from satellites which are not in direct LOS.

Each UPN is able to use GPS signal information such as signal strength, convergence, number of satellites, signal stability, etc to establish the expected error of their local GPS time synch. Systems which are experiencing a high amount of error due to poor or no signal can request timing information from their local neighbors. These neighbors can then be synchronized to a second degree of accuracy using UWB signals. This affect can be dynamic, and can be propagated through the UWB network through as many nodes as necessary.

For example, in a situation such as a tunnel where no nodes can receive a GPS signal, they would report to their local neighbors that they have no GPS timing information (analogous to extremely high error), this information would be propagated outward from each UPN in the tunnel until reaching a node which is in GPS coverage, this node would then be able to communicate the global timing information back to the nodes in the tunnel. In this way, all nodes in this network are now synchronized to a second degree of accuracy relative to each other, and their global timing accuracy is to the same level of accuracy as the single node which is able to receive GPS timing information.

The movably positioned object 226 in the subset of the upper portion 240 of FIG. 2 is shown receiving 3 separate TDOA transmissions 234, and has initiated a TWR 236 with a fourth UPN 208. It is also sharing positional and state information with another movably positioned object using DSRC 238. The scheduling of these transmissions is based on the constellation referenced time that is set to the common GPS 246, 242 radio time stamp. However, as both the movably positioned object and each UPN possess the same reference time they can also hold that time to a second degree of accuracy. This second degree of accuracy can and is, in this embodiment, greater than that of the first degree of accuracy. Thus, even though the reference time of the UPNs and the movably positioned object in the upper subset 240 may differ from that of the objects and UPNs in the lower subset 242 of the constellation, their local reference time is more precise resulting in a more precise positional determination. For example, the reference time in the upper subset 240 may be 12:01:01000021 while the reference time in the lower subset 242 may bet 12:01:01000024.

As the movably positioned object measures the time difference between transmission and reception, that difference is accurate, in this embodiment, to a picosecond. Similarly, measurements conducted using TWR also achieve picosecond resolution. And as the entire constellation is synchronized at a nanosecond degree of accuracy, these precise locations can be shared among all UPNs and movably positioned objects.

Another aspect of the present invention is to extend this degree of accuracy in areas that are denied GPS reception. As is well known, GPS signal reception requires a direct line of sight with a GPS satellite. Weather, mountains, urban canyons, tunnels and the like can all degrade or impede reception. In those instances, and according to one embodiment of the present invention, the reference radio signal time can be propagated using UWB transmissions.

Reference to the lower subset portion 242 of FIG. 2 shows a movably positioned object 232 in an urban environment that is part of a constellation of UWB nodes. The movably positioned object 232 is within the effective range of at least three UPNs 216, 218, 220 and another movably positioned object 230. The rightmost UPNs 216, 220 are shown to represent a clear line of sight with a GPS satellite 242 from which the radio time signal can be gained. The two leftmost UPNs 214, 218 are positioned within an area, such as a tunnel, in which direct line of sight communication with the GPS satellite is either degraded or occluded. In such instances, and according to one embodiment of the present invention, the radio time signal received from the GPS satellite 242 by the two rightmost UPNs 216, 220 propagates the new node reference time to the two leftmost UPNs 214, 218. As a result, each of the four UPNs within effective transceiver range of the movably positioned object 232 share the constellation common reference time at the first degree of accuracy. And each of these four UPNs, with respect to each other, share a subset reference time to the higher, second degree of accuracy.

The present invention crafts UPN subsets from which precise positional determination can be obtained. Using UWB pulsed TDOA and TWR, picosecond or better resolution can be ascertained resulting in precise positional determination. Each subset of UPNs can operate independently at this second degree of accuracy while still sharing a common constellation time on which to base DSRC communication.

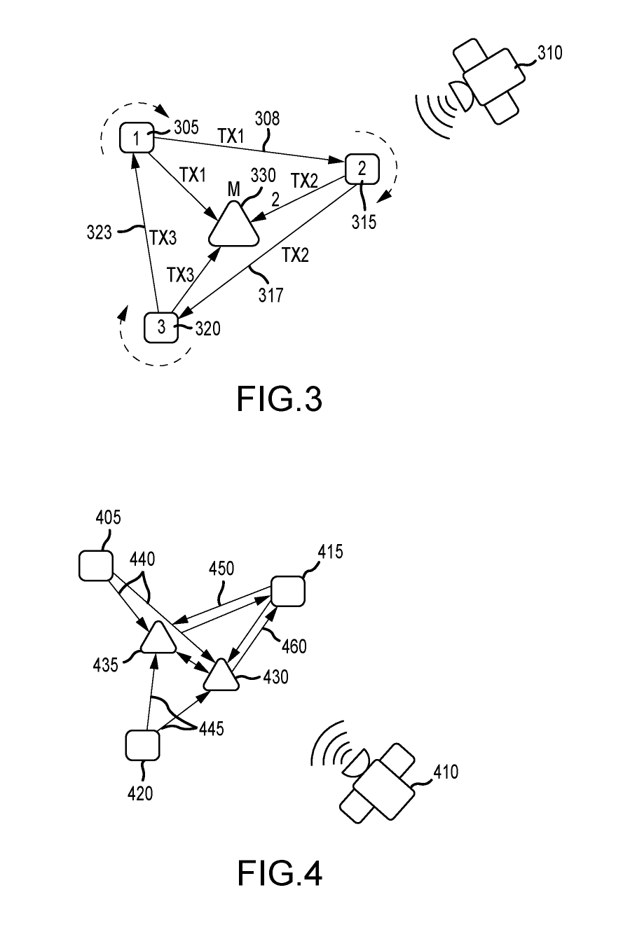

FIG. 3 is an illustration of a pulsed based Time Distance of Arrival offset based on a synchronized radio time signal from a GPS satellite 310 according to one embodiment of the present invention. As previously introduced each of the plurality of UPNs 305, 315, 320 in the UWB constellation can adopt a GPS radio time signal to establish a constellation common reference time. Once adopted each UPN can transmit a signal followed by a very precise, predetermined delay.

In FIG. 3, UPN 1 305 transmits Tx₁ 308 that is received by both movably positioned object M 330 and UPN 2 315. Upon receipt of Tx₁ 308 and in accordance with a slot map schedule, UPN 2 315 transmits Tx₂ 317. Tx₂ 317 is received by M 330 and UPN 3 320. Again, after a precise and predetermined delay, UPN 3 320 transmits Tx₃ 323. Movably positioned object 330 receives three separate transmissions from three separate UPNs at very precise and know time intervals. Moreover, the differences in time from transmission to reception can be determined since the location of each UPN is known and the exact time at which each transmission originates is known.

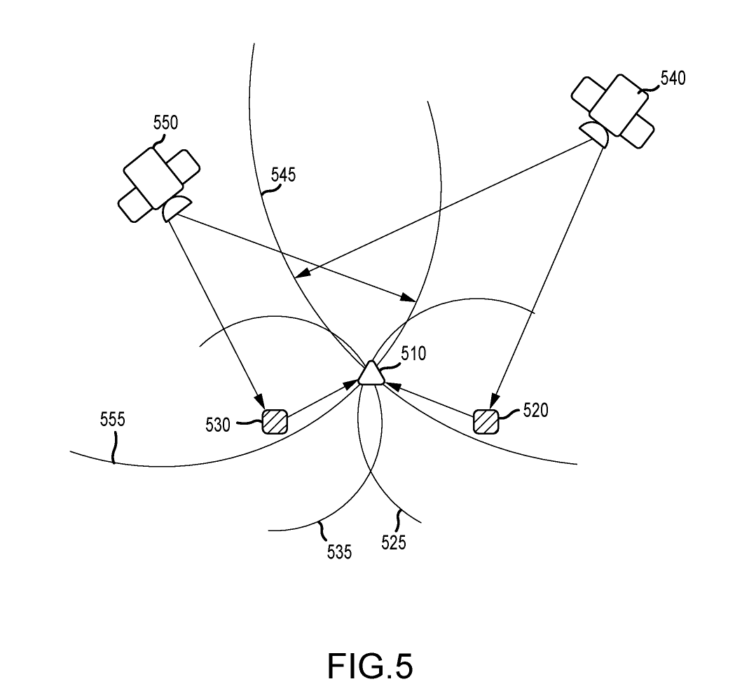

FIG. 4 provides a rendering of two movably positioned objects and three UPNs using a combination of TDOA and TWR to ascertain the location of each movably positioned node at a common time reference. Carrying on the concept discussed with respect to FIG. 3, three UPNs 405, 415, 420 are within the effective reception range of two movably positioned objects 430, 435. Each is coarsely synchronized with the GPS radio signal time originating from a GPS satellite 410 enabling DSRC and peer-to-peer communication.

In this example, each of the movably positioned objects 430, 435 receives a TDOA transmission 440, 445 from two UPNs 405, 420 and initiate separate TWR conversations 450, 460 with the third UPN 415. The TDOA transmissions to both movably positioned objects and each TWR conversation are sequential. Each result in a time difference measurement that can be used to determine positions of each movably positioned object at the same point in time.

Another aspect of the present invention is to extend the use of fused TDOA and

TWR measurements to those signals gained from GPS satellites. According to one embodiment of the present invention, TDOA information gained from GPS signals can be married with UWB TDOA and TWR measurements to provide a robust and efficient positional determination.

UWB TDOA and TWR is, as discussed herein, more accurate than GPS. While

GPS positional accuracy can be measured in feet or meters, UWB TDOA and TWR positioning is accurate to within 2-5 centimeters. The inaccuracies of GPS are often due to the inability of the receiver to gain a clear signal from three or more GPS satellites. In some instances, one or two of these signals is not degraded and possesses a high degree of accuracy. But its combination with another, degraded signal, significantly diminishes the GPS to provide reliable and accurate positional determinations in certain environments. But there are conditions in which GPS signals can aid in determining an objects position.

As a movably positioned object transitions from a rural environment to an urban environment, GPS signals become less reliable resulting in decreased positional accuracy. In rural environment, UPNs may be sparsely located and positional determines may rely more heavily on GPS. As the object enters the urban area and UWB nodes become more prevalent, the determination of an objects position can transition to UWB TDOA and TWR. One embodiment of the present invention dynamically combines UWB TDOA and TWR positional determination techniques with those of GPS.

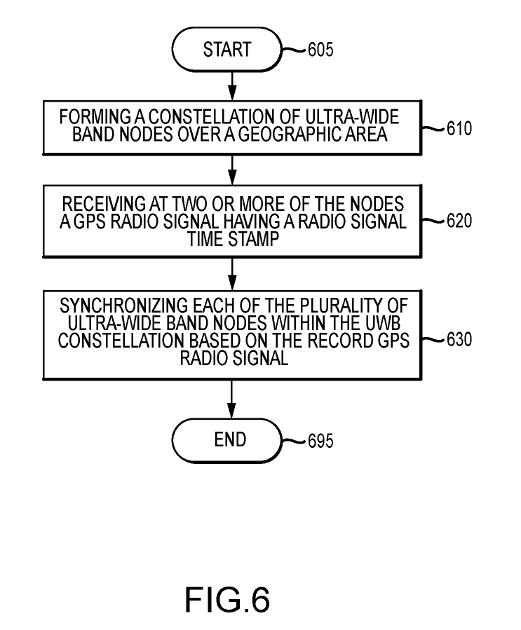

FIG. 5 illustrates the positional determination of an object by merging UWB and GPS positional techniques, according to one embodiment of the present invention. A movably positioned object 510, as shown in FIG. 5, is within the UWB transceiver reception range of two UPNs 520, 530. In another embodiment, the object may be within range of other UPNs but it is more efficient to use a combination of UWB and GPS signals rather than rely solely on UWB transmissions.

In this case, two UPNs 520, 530 have aligned their UPN node reference time with the radio signal time generated by GPS satellites 540, 550. Each UPN 520 530 transmits one or more pulses that are received by the movably positioned object 510. Included in the pulse can be data indicating the location of the UPN. In this case, the movably positioned object develops two TDOA hyperboloids 525, 535 that overlap. Lacking a third or fourth UPN, these transmissions alone would be insufficient to provide the movably positioned object with a positional determination.

Similarly, the movably positioned object 510 is in reception of two GPS signals 545, 555. Along with synchronizing the object reference time, the GPS signals are of sufficient strength to establish reliable pseudo-ranges but with only two satellites no positional determination is possible.

One embodiment of the present invention combines positional information obtained from GPS signal(s) with that obtained using one or more UPNs. The combinations are dynamic and based on an assessment of error. For example, situations may exist in which three UPN TDOA or TWR calculations are combined with a single GPS pseudo-range. In another instance, a single UPN calculation may be combined with three GPS pseudo-ranges.

Moreover, a wide variety of techniques can be combined to arrive at a single positional determination. For example, a single pseudo-range from a GPS satellite can be combined with two TDOA hyperboloids and a single TWR spheroid to arrive at a positional determination. In each case, error is assessed and minimized to arrive at the most precise and reliable positional determination.

Another aspect of the present invention is to tightly couple the UWB constellation with the GPS or other GNSS sensor networks to enhance GNSS sensor network performance. Real Time Kinematic (RTK) satellite navigation is a technique used to enhance the precision of position data derived from satellite-based positioning systems (such as GPS, GLONASS, Galileo, and BeiDou). It uses measurements of the phase of the signal's carrier wave, rather than the information content of the signal, and relies on a single reference station or interpolated virtual station to provide real-time corrections, providing up to centimeter-level accuracy. With reference to GPS in particular, the system is commonly referred to as Carrier-Phase Enhancement, or CPGPS.

RTK base stations are essentially fixed GPS receivers that have a surveyed location. They provide correction information to mobile GPS receivers which use that correction information to refine the accuracy of the GPS signal. But the disadvantages of a RTK sensor network is the same as the normal problems of GPS; multipath, occlusion, etc. Occlusion to the satellite and multipath are especially harmful to RTK GPS systems, mostly because while they are trying to achieve 5 cm or less of accuracy multipath can throw in 10 or even 100 meters of inaccuracy making the system very unreliable. Accordingly, RTK has not achieved wide-spread adoption.

There are two frequencies for each satellite in a GNSS constellation. GPS uses the L1 and L2 frequency. The L1 frequency is used for civilian purposes while L2 frequency is a military only frequency or is used by private companies that have access via a special licenses. That being said, L2 can still be used for RTK correction purposes.

One aspect of the present invention is to augment the UWB constellation with RTK base stations. RTK base stations do not need to be as prevalent as the UPNs and may, in one embodiment, be placed with a 1:10 ratio as compared to UPNs. The RTK base station's location is known. The density of UPNs can be dynamic depending the availability of GNSS. In an area with no obstructions blocking a view of the sky, UPNs may be spaced such that only 1 is within range at any given time, in order to provide GNSS correction/RTK information, as well as range information. With current range constraints, this spacing would be on the order of 1 per 500 m, which is also sufficient for RTK correction station density. The other extreme would be an area such as a tunnel with no GNSS availability, in this case UWB is the only source of RF positioning information so the node density would be closer to 1 every 50 m. This density could be determined by analyzing the GNSS availability data in certain regions, either through simulation or data collection. Node density may also be higher than strictly required by GNSS availability in order to provide redundancy or extra robustness. In this way the density of nodes can be tailored to the specific environment and use case. By doing so it can provide information to correct distorted GPS signals from atmosphere conditions. Moreover, and more importantly, they provide phase information of the L1 signals. This phase information can be embedded into the UWB signals to enhance precision.

The phase information provides a list of possible solutions based on the phase at the GPS receiver's location and the wavelength of the signal. This is because the signal is repeating. Thus, for a GPS signal there are a set of possible solutions on which the receiver could be located based on the phase of the signal. The RTK station can resolve this ambiguity but it takes a great deal of time and, as stated before, is unreliable. Using the range information from a UWB radio that is within range of the RTK base station, the RTK base station can resolve the phase ambiguity in the RTK signal much faster than with the L1 and L2 combined signal, alone. The resulting combination enables GPS signals to be effectively combined with UWB positional techniques for positional determination. Using UWB allows resolving phase ambiguity much faster than an L1 only system, but at a much lower cost than an L1+L2 system. In other words, L1+UWB is just as good and lower cost than an L1+L2 system. Obviously UWB can still help an L1+L2 system, but requiring each UPN to only measure L1 phase significantly reduces cost. The mobile object generally must resolve the phase ambiguity. It does this by comparing phase information sent from the base station with its own phase information, and elimination impossible locations until there is 1 that is clearly more likely. Using the UWB range or TDOA measurement allows the mobile to reduce this ambiguity much more quickly since it is accurate to 1 cm.

Included in the description are flowcharts depicting examples of the methodology which may be used synchronize a UWB constellation. In the following description, it will be understood that each block of the flowchart illustrations, and combinations of blocks in the flowchart illustrations, can, in certain embodiments, be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware or special purpose computer systems that perform the specified functions or steps, or combinations of special purpose hardware and computer instructions.

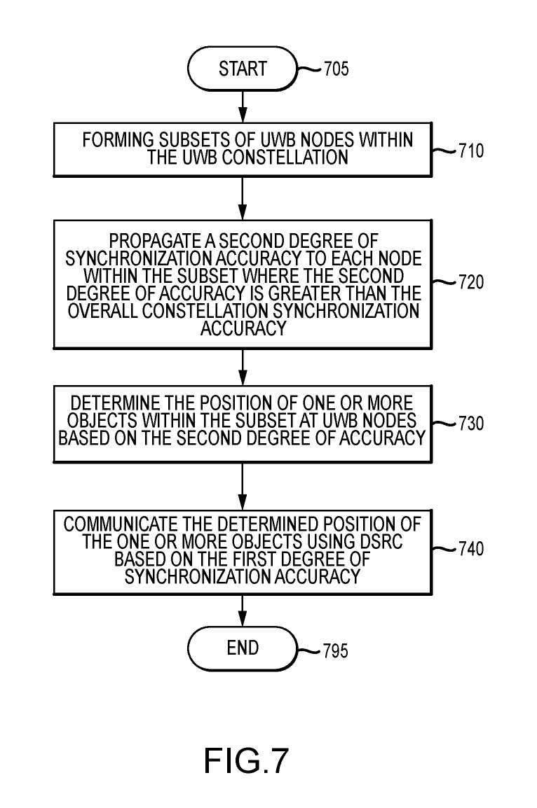

FIG. 6 is one embodiment of a methodology for forming a UWB constellation according to one embodiment of the present invention. The process begins 605 by fixedly locating 610 a plurality of UPNs throughout a geographic area. Each UPN's location is known. In one embodiment, each node maintains a list of all UPN locations and in another embodiment each node includes its location with the data transmitted to other nearby or requesting nodes.

Each UPN includes, among other things, a UWB transceiver and a radio transceiver. The radio transceiver receives 620 radio signals including a radio signal having a timestamp. In one embodiment, the radio transceiver is a GPS transceiver and the radio signal is a GPS signal. Upon receiving the radio signal with a time stamp, the UPNs are synchronized 630 with the radio time stamp forming a constellation common reference time.

As continued in FIG. 7, another methodology embodiment of the present invention forms 710 UPN subsets within the UWB constellation. While the entire constellation is synchronized to a constellation common reference time based on the received radio signal time having a first degree of accuracy, subsets within the constellation can establish, propagate 720, and maintain their synchronization at a second, more accurate degree of synchronization. In doing so, timing calculations are more precise and positional determinations more accurate. While more accurate in positional determination, communication 740 of an objects position at a point of time can remain at the first degree of accuracy to promote DSRC exchange of data.

Another aspect of the present invention is a methodology to combine GPS pseudo ranges and distance determinations based on UPNs. The methodology recognizes that in some instances three or more distance determination required to ascertain an object's positon are not available using GPS or UPN technology alone. In those instances, one aspect of the present invention is combining GPS pseudo ranges with UPN determined ranging to ascertain the position of the object.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

In a preferred embodiment, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, flash memory or the like. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network as well as in an independent computing environment. In a distributed computing environment, program modules may be located in both local and remote memory storage devices.

An exemplary system for implementing the invention includes a general-purpose computing device such as a personal communication device or the like, including a processing unit, a system memory, and a system bus that connects various system components, including the system memory to the processing unit. The system bus may be any of several types of bus structures including a memory bus or memory controller, a peripheral bus, and a local bus using any of a variety of bus architectures. The system memory generally includes read-only memory (ROM) and random-access memory (RAM). A basic input/output system (BIOS), containing the basic routines that help to transfer information between elements within the personal computer, such as during start-up, is stored in ROM. The computer may further include a hard disk drive or similar storage device for reading from and writing to a hard disk, a magnetic disk drive for reading from or writing to a removable magnetic disk or the like. The hard disk drive and magnetic disk drive are typically connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

The present invention uses a plurality of light poles or traffic lights or the like, each equipped with a UWB node, UPN, to create a fully connected, synchronized, network. The UWB nodes communicate to one another with a combination of software algorithms written, in one embodiment, with C++ and run on Linux. One of reasonable skill in the relevant art will recognize that other programing languages and operating systems can be used to facilitate the implementation of the concepts presented herein without departing from the scope and intent of the present invention. The Internet and dedicated network connections can be used depending on the task performed and messaging passed between nodes. The layers in this mobility platform and the UPNs include the network connections, an Operating System such as Linux, a software frameworks such as the open source Robot Operating system (ROS), messaging, data extraction, and devices along with 3rd party products (both hardware and software) to create a fully connected network. Indeed, given typical light pole spacing and current UWB capability at least six would be in range of each other at all times forming a system that can effectively filter out/use multi-path and provide redundancy and verification. Light poles are generally spaced at optimal distance for visual light reflectivity but the present invention provides flexibility as the peer-to-peer range of the UWB modules can currently reach 350 meters.

The UPNs of the present invention can be easily integrated with DSRC radios that enables the most reliable, high speed vehicle-based technology for crash prevention safety applications. DSRC by itself is responsible for communication between vehicles and infrastructure. It provides for a broad cross-section of dedicated connectivity options for surface transportation safety but does not track the vehicles' position. Hence with UPN integration, a notification from DSRC can tell the driver about hazards in a vicinity with respect to its exact location to make intelligent decisions and prevent accidents on roads.

With such accurate positioning, UPNs can share corrected GPS signals with vehicles using DSRC links for both V2V and V2I applications. Since both UPN and DSRC technology are independent of GPS, they enable precise positioning and safety communications in GPS denied areas. The technology of the present invention is not only beneficial for safety of manned vehicles but in the future can be scaled to be used by driverless vehicles for autonomous transportation. The present invention's positioning solution can create a transportation infrastructure that can be coherently used both by humans and machines.

Using a time signal from a radio signal such as GPS, the UWB constellation can be synchronized. And while the entirety of the constellation is synchronized to a nanosecond level of accuracy, local subsets of UPNs can establish even finer degrees of synchronization resulting in more accurate positional determination. These synchronization signals can be propagated to other nodes that are denied or incapable of receiving synchronizing radio signals. Moreover, in cases in which a plurality of UPNs is unavailable to accurately determine an objects position, available UPN nodes can be combined with GPS pseudo-ranges to achieve positional determination.

While there have been described above the principles of the present invention in conjunction with a UWB constellation, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. An Ultra-Wide Band geographic positioning system, comprising:
a plurality of fixedly positioned Ultra-Wide Band (UWB) Positional Nodes forming a constellation within a geographic area wherein each UWB Positional Node (UPN) includes an UPN UWB transceiver and an UPN radio transceiver and wherein each UPN is within an effective UPN UWB transceiver range of two or more other UPNs and wherein each UPN includes a clock that maintains a node reference time;
a radio signal, transmitted by a radio and received by one or more UPNs in the geographic area wherein the radio signal includes a radio signal time; and
at each UPN, a processor, communicatively coupled to the UPN radio transceiver and the clock, that synchronizes the node reference time maintained by the clock to the radio signal time.

2. The Ultra-Wide Band geographic positioning system of claim 1, wherein each UPN synchronizes its node reference time to the radio signal time based on a dynamic weighted average error assessment of the node reference time and the radio signal time.

3. The Ultra-Wide Band geographic positioning system of claim 2, wherein responsive to determination by a first UPN that the dynamic weighted average error assessment exceeds a predetermined threshold, the first UPN synchronizes its node reference time with the node reference time of a second UPN, wherein the second UPN is within the effective UWB transceiver range of the first UPN.

4. The Ultra-Wide Band geographic positioning system of claim 1, wherein the radio signal time is a constellation common reference time and wherein the constellation common reference time is associated with a first degree of accuracy.

5. The Ultra-Wide Band geographic positioning system of claim 4, wherein the plurality of UPNs forming the constellation includes a first subset of UPNs and a second subset of UPNs and wherein the first subset of UPNs establishes a first subset reference time having a second degree of accuracy based on the constellation common reference time, and wherein the second subset of UPNs establishes a second subset reference time having a third degree of accuracy based on the constellation common reference time and wherein the second degree of accuracy is greater than the first degree of accuracy and wherein the third degree of accuracy is greater than the first degree of accuracy and wherein the first subset time is independent from the second subset time.

6. The Ultra-Wide Band geographic positioning system of claim 5, wherein the first subset of UPNs includes a movably positioned object having an object reference time and wherein the movably positioned object synchronizes the object reference time with the first subset reference time and the second degree of accuracy for positional determination.

7. The Ultra-Wide Band geographic positioning system of claim 4, wherein the first subset of UPNs includes a schedule for Time Difference of Arrival transmissions and wherein the schedule is based on the constellation common reference time and the first degree of accuracy.

8. The Ultra-Wide Band geographic positioning system of claim 1, wherein the radio signal is a global positioning system (GPS) signal.

9. The Ultra-Wide Band geographic positioning system of claim 8, wherein each UPN UWB transmitter propagates the node reference time using a UWB pulse.

10. The Ultra-Wide Band geographic positioning system of claim 9, wherein a movably positioned object within the geographic area synchronizes an object reference time with the node reference time received from the UWB pulse.

11. The Ultra-Wide Band geographic positioning system of claim 1, wherein each Ultra-Wide Band (UWB) Positional Nodes is fixedly positioned at a known location.

12. The Ultra-Wide Band geographic positioning system of claim 1, wherein the common node time is propagated throughout the constellation using a Dedicated Short-Range Communications (DSRC) radio signal.

13. The Ultra-Wide Band geographic positioning system of claim 1, further comprising two or more movably positioned objects within the geographic area wherein each movably positioned object includes an object reference time, an object UWB transceiver having an object UWB transceiver effective range and wherein each movably positioned object synchronizes its object reference time with a weighted average of each node reference time received from two or more UPNs within the object UWB transceiver effective range and determines its position within the geographic area.

14. The Ultra-Wide Band geographic positioning system of claim 13, wherein a first movably positioned object determines its position at a first point in time, and communicates its position at the first point of time with the two or more UPNs within the UWB transceiver effective range and wherein a second movably positioned object determines its position at the first point in time, and communicates its position at the first point of time with the two or more UPNs within the UWB transceiver effective range.

15. The Ultra-Wide Band geographic positioning system of claim 14, wherein the first movably positioned object and the second movably positioned object communicate their position to each other at the first point of time.

16. The Ultra-Wide Band geographic positioning system of claim 1, further comprising a movably positioned object within the geographic area wherein the movably positioned object includes an object reference time maintained by an object clock, a processor, an object UWB transceiver within an object UWB transceiver effective range and wherein the movably positioned object is within the object UWB transceiver effective range of one or more UPNs, and an object radio transceiver that one or more global positioning system (GPS) signals transmitted from a plurality of GPS radios and wherein each UPN node reference time within an object UWB transceiver effective range, the object reference time and the radio signal time are synchronized.

17. The Ultra-Wide Band geographic positioning system of claim 16, wherein the processor determines a position of the movably positioned object by combining time differences of arrival of measurements gained from signals transmissions by one or more UPNs within the object UWB transceiver effective range and one or more GPS signals transmitted from a plurality of GPS radios.

18. A method for positional determination in a geographic area, the method comprising:
fixedly positioning a plurality of Ultra-Wide Band (UWB) Positional Nodes within a geographic area forming a UWB constellation wherein each UWB Positional Node (UPN) includes, a processor, an UPN UWB transceiver, a UPN radio transceiver and a clock that maintains a node reference time;
receiving, by the UPN radio transceiver, a radio signal wherein the radio signal includes a radio signal time; and
synchronizing the node reference time maintained by the clock to the radio signal time.

19. The method for positional determination in a geographic area according to claim 18, wherein the radio signal time is a constellation common reference time and wherein the constellation common reference time is associated with a first degree of accuracy.

20. The method for positional determination in a geographic area according to claim 19, wherein forming the UWB constellation includes forming a first subset of UPNs and forming a second subset of UPNs and further comprising establishing a first subset reference time by the first subset of UPNs having a second degree of accuracy based on the constellation common reference time, and establishing a second subset reference time by the second subset of UPNs having a third degree of accuracy based on the constellation common reference time and wherein the second degree of accuracy is greater than the first degree of accuracy and wherein the third degree of accuracy is greater than the first degree of accuracy and wherein the first subset time is independent from the second subset time.

21. The method for positional determination in a geographic area according to claim 20, wherein the first subset of UPNs includes a movably positioned object having an object reference time and further comprising synchronizing the object reference time by the movably positioned object with the first subset reference time and the second degree of accuracy for positional determination.
